(19) United States
(12) Patent Application Publication
(10) Pub. No.: US 2024/0090501 A1
(43) Pub. Date: Mar. 21, 2024

(54) STABLE AGROCHEMICAL COMPOSITION

(71) Applicant: UPL Limited, Mumbai (IN)

(72) Inventors: Rajan Ramakant Shirsat, Mumbai (IN); Anil Saini, Mumbai (IN); Kalpesh Parimal Chokashi, Mumbai (IN); Popat Ganesh Chavan, Mumbai (IN); Tusharkumar Bhagwat Chakhale, Mumbai (IN)

(21) Appl. No.: 18/263,575

(22) PCT Filed: Feb. 3, 2022
(86) PCT No.: PCT/IB2022/050938

§ 371 Date: Jul. 31, 2023

(30) Foreign Application Priority Data
Feb. 5, 2021 (IN) 202121005077

(51) Int. Cl. A01N 43/56; A01N 25/14; A01N 25/30; A01N 43/90; A01N 47/40; A01N 53/00; A01P 7/04

(52) U.S. Cl. CPC A01N 43/56; A01N 25/14; A01N 25/30; A01N 43/90; A01N 47/40; A01N 53/00; A01P 7/04

(57) ABSTRACT

Disclosed herein is a stable agrochemical composition including: a) at least one diamide insecticide; and b) an integrity retaining system including a disintegrant and at least two anionic surfactants. Also disclosed is a process of preparing the agrochemical composition and a method of controlling plant pests with the agrochemical composition.

### FIELD OF THE DISCLOSURE

The present disclosure relates to a stable agrochemical composition and in particular, a stable agrochemical composition of a diamide insecticide in the form of water dispersible granules.

### BACKGROUND OF THE DISCLOSURE

To enable efficient elimination or controlling of unwanted insects in agricultural and other applications, it is desirable to use effective chemical insecticides.

A water dispersible granular (WDG) formulation is a solid formulation that generally incorporates the active ingredient into a granule which disperses or dissolves quickly when added to water in the spray tank to give a fine particle suspension. WDG formulations provide a system for delivering solid active ingredients to their target and allow for the production of highly concentrated formulations which are wettable and readily disintegrate on contact with water. These types of formulations present advantages in terms of storage as well as in terms of handling and toxicity.

Rapid disintegration is important for the efficient dispersion of WDG formulations in water and is also an important index for evaluating the performance of WDG formulations. When hydrophobic agrochemicals are formulated as a WDG, disintegration of the WDG becomes the major concern. Although WDG formulations are optimized to improve disintegration properties, there has been limited research into the factors influencing the disintegration performance of WDGs, especially when the active ingredient is a hydrophobic agrochemical.

Other than disintegration, an important aspect associated with the preparation of a WDG is attrition. In particular, granules with low resistance to attrition and abrasion are prone to dusting as they fail to withstand handling and shipping and turn to dust. While the rates of dusting and attrition are much better in WDG than other solid formulations such as a wettable powder (WP), controlling the attrition rate and dusting remains very important when a hydrophobic active ingredient is incorporated in the granules in a very small quantity.

Retaining the integrity of a WDG formulation including a reduced amount of active ingredient is highly desirable in order to ensure a sufficient quantity of active ingredient is present to provide the required dose rate, otherwise, the WDG formulation will become ineffective. Moreover, dusting exposes the operator/formulator to harmful chemicals and poses health hazards.

There thus remains a need to develop WDG formulations which address the challenges associated with dusting and attrition as well as performance challenges of dispersibility, suspensibility and foaming.

### Objectives of the Disclosure

An objective of the present disclosure is to provide a stable agrochemical composition comprising a diamide insecticide.

Yet another objective of the present disclosure is to provide a stable agrochemical composition comprising a diamide insecticide in the form of water dispersible granules.

Yet another objective of the present disclosure is to provide a stable agrochemical composition comprising a diamide insecticide with improved suspensibility, controlled foam, improved dispersibility and/or controlled attrition.

Yet another objective of the present disclosure is to provide a stable agrochemical composition comprising a diamide insecticide in combination with other insecticides in the form of water dispersible granules.

Yet another object of the present disclosure is to provide process of preparing stable agrochemical composition comprising a diamide insecticide.

Still another object of the present disclosure is to provide method of controlling pests using stable agrochemical composition comprising a diamide insecticide.

### SUMMARY OF THE DISCLOSURE

In an aspect, the present disclosure provides an agrochemical composition comprising:
a) at least one diamide insecticide; and
b) an integrity retaining system comprising a disintegrant and at least two anionic surfactants.

In an aspect, the ratio of disintegrant to the at least two anionic surfactants is from about 0.5:1 to about 5:1.

In another aspect, the present disclosure provides an agrochemical composition comprising:
a) at least one diamide insecticide;
b) at least one additional insecticide; and
c) an integrity retaining system comprising a disintegrant and at least two anionic surfactants.

In another aspect, the present disclosure provides a process of preparing an agrochemical composition comprising:
i. combining at least one diamide insecticide, a disintegrant, at least two anionic surfactants, and optionally an auxiliary ingredient to provide a blend;
ii. mixing and homogenizing the blend;
iii. granulating the mixed and homogenized blend to obtain the agrochemical composition comprising at least one diamide insecticide and an integrity retaining system comprising the disintegrant and the at least two anionic surfactants.

In another aspect, the present disclosure provides a process of preparing an agrochemical composition comprising:
i. combining at least one diamide insecticide, a disintegrant, at least two anionic surfactants, and optionally an auxiliary ingredient to obtain a blend;
ii. grinding the blend to obtain a ground mixture comprising particles having a predetermined particle size;
iii. blending the ground mixture to obtain a homogeneous mixture;
iv. preparing a dough from the homogeneous mixture and preparing granules from the dough;
v. drying the granules to obtain the agrochemical composition comprising: (a) at least one diamide insecticide; and (b) an integrity retaining system comprising the disintegrant and the at least two anionic surfactants.

In another aspect, the present disclosure provides a method of controlling plant pests comprising applying to the plant or a locus thereof an effective amount of an agrochemical composition comprising:
a) at least one diamide insecticide; and
b) an integrity retaining system comprising a disintegrant and at least two anionic surfactants.

### DETAILED DESCRIPTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of the terms “a” and “an” and “the” and similar referents (especially in the context of the following claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers. The terms “comprising”, “having”, “including”, and “containing” are to be construed as open-ended terms (i.e., meaning “including, but not limited to”) unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

While the invention has been described with reference to an exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context. “Alkyl” means a straight or branched chain saturated aliphatic hydrocarbon having the specified number of carbon atoms, specifically 1 to 12 carbon atoms, more specifically 1 to 6 carbon atoms. Alkyl groups include, for example, groups having from 1 to 50 carbon atoms (C1 to C50 alkyl).

“Aryl” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

As used herein, the term “pest” refers to an organism, and in particular an insect, which is detrimental to the growth, reproduction, and/or viability of a plant, a portion of the plant or a plant seed.

The term “control” as it relates to a pest, includes the killing of the pest, as well as protecting a plant, a portion of the plant, or a plant seed from attack or invasion by said pest.

The term “suspensibility” refers to the ability of particles to be suspended in a diluent (e.g., water) without settling.

The terms “diamide insecticide” or “diamide based insecticide” are used herein interchangeably and refer to an insecticide including a two amide groups.

As used throughout the disclosure, the diamide insecticide or other active ingredients, include their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods. A “solvate” means the insecticide or its pharmaceutically acceptable salt, wherein molecules of a suitable solvent are incorporated in the crystal lattice. A suitable solvent is physiologically tolerable at the dosage administered. Examples of suitable solvents are ethanol, water and the like. When water is the solvent, the molecule is referred to as a “hydrate”. The formation of solvates will vary depending on the compound and the solvate. In general, solvates are formed by dissolving the compound in the appropriate solvent and isolating the solvate by cooling or using an antisolvent. The solvate is typically dried or azeotroped under ambient conditions. In an aspect, the solvate is a hydrate

Unless otherwise defined, all technical and scientific terms used herein have the same meaning as commonly understood by one of ordinary skill in the art to which this disclosure belongs. The terminology used in the description of the disclosure herein is for the purpose of describing particular embodiments only and is not intended to be limiting of the disclosure.

While developing a granular formulation of a diamide based insecticide (diamide insecticide), it was surprisingly found that the integrity of water dispersible granules of the diamide insecticide can be maintained using a combination of a disintegrant and at least two anionic surfactants. The combination of disintegrant and at least two anionic surfactants in a particular ratio not only facilitates granule formation but also provides quick disintegration of the active when the granule is dispersed in water for field application. The combination of the disintegrant and the anionic surfactants in a weight ratio of 0.5:1 to about 5:1 was found to successfully retain the integrity of a diamide insecticide (e.g., chlorantraniliprole) based formulation alone or in combination with another active ingredient. It was also surprisingly found that the combination of disintegrant and at least two anionic surfactants resulted in greater suspensibility and dispersibility of the diamide insecticide. The integrity retaining system also supported the compositions to exhibit controlled foaming behaviour.

As used herein, the term “integrity retaining system” refers to a combination of disintegrant and anionic surfactants that facilitates granulation of diamide based insecticides, their quick disintegration when dispersed in water, and controlled foam generation.

Disintegrating agents are considered important excipients, which facilitate the disintegration (breaking) of the granule when it comes in contact with a diluent. Commonly used disintegrants in agrochemical formulations are ammonium salts such as ammonium sulfate, ammonium phosphate, and ammonium nitrate; and mineral clays such as kaolinite, talc, and gypsum. In addition to disintegrants, the WDGs can comprise one or more excipients having a specific function, such as surfactants for wetting and dispersion, binders, antifoam agents, and diluents. The performance of a disintegrant can be altered significantly when mixed with various excipients. Water wetting or the granule surface and diffusion of the water to the inner space of WDGs have been identified as steps necessary in the disintegration process. Therefore, the choice of disintegrant and surfactant becomes essential for WDGs to achieve sufficient disintegration. Generally, disintegrants are hygroscopic in nature and if they absorb moisture from the air, there is a potential to impair the stability of the WDG formulation. Thus, the choice of excipients is crucial in order to develop a stable composition.

Accordingly, in an embodiment of the present disclosure, a stable agrochemical composition comprises:
a) at least one diamide insecticide; and
b) agrochemically acceptable excipients.

Accordingly, in an embodiment of the present disclosure, a stable agrochemical composition comprises:
a) at least one diamide insecticide; and
b) an integrity retaining system comprising a disintegrant and at least two anionic surfactant.

The diamide insecticide comprises afoxolaner (4-(5-(3-chloro-5-(trifluoromethyl)phenyl)-5-(trifluoromethyl)-4H-1,2-oxazol-3-yl)-N-(2-oxo-2-(2,2,2-trifluoroethylamino)ethyl)naphthalene-1-carboxamide), broflanilide (N-(2-bromo-4-(1,1,1,2,3,3,3-heptafluoropropan-2-yl)-6-(trifluoromethyl)phenyl)-2-fluoro-3-(N-methylbenzamido)benzamide), chlorantraniliprole (CTPR; 3-bromo-N-[4-chloro-2-methyl-6-(methylcarbamoyl)phenyl]-1-(3-chloropyridin-2-yl)-1H-pyrazole-5-carboxamide), cyantraniliprole (3-bromo-1-(3-chloropyridin-2-yl)-N-[4-cyano-2-methyl-6-(methylcarbamoyl)phenyl]-1H-pyrazole-5-carboxamide), cyclaniliprole (rac-3-bromo-N-(2-bromo-4-chloro-6-{[(1R)-1-cyclopropylethyl]carbamoyl}phenyl)-1-(3-chloropyridin-2-yl)-1H-pyrazole-5-carboxamide), cyhalodiamide (3-chloro-N2-(2-cyanopropan-2-yl)-N1-(4-(1,1,1,2,3,3,3-heptafluoropropan-2-yl)-2-methylphenyl)benzene-1,2-dicarboxamide), flubendiamide (N1-[4-(1,1,1,2,3,3,3-heptafluoropropan-2-yl)-2-methylphenyl]-3-iodo-N2-[1-(methanesulfonyl)-2-methylpropan-2-yl]benzene-1,2-dicarboxamide), fluralaner (4-(5-(3,5-Dichlorophenyl)-5-(trifluoromethyl)-4,5-dihydro-1,2-oxazol-3-yl)-2-methyl-n-(2-oxo-2-((2,2,2-trifluoroethyl)amino)ethyl)benzamide), lotilaner (3-methyl-N-{2-oxo-2-[(2,2,2-trifluoroethyl)amino]ethyl}-5-[(5S)-5-(3,4,5-trichlorophenyl)-5-(trifluoromethyl)-4,5-dihydro-1,2-oxazol-3-yl]thiophene-2-carboxamide), tetrachlorantraniliprole (3-bromo-N-[2,4-dichloro-6-(methylcarbamoyl)phenyl]-1-(3,5-dichloropyridin-2-yl)-1H-pyrazole-5-carboxamide), tetraniliprole (1-(3-chloropyridin-2-yl)-N-[4-cyano-2-methyl-6-(methylcarbamoyl)phenyl]-3-([5-(trifluoromethyl)-2H-tetrazol-2-yl]methyl)-1H-pyrazole-5-carboxamide), or a combination thereof.

According to an embodiment of the present disclosure, the diamide insecticide comprises chlorantraniliprole, cyantraniliprole, cyclaniliprole, tetrachlorantraniliprole, tetraniliprole, or a combination thereof.

According to an embodiment, the diamide insecticide of the stable agrochemical composition is chlorantraniliprole.

According to an embodiment, the diamide insecticide of the stable agrochemical composition is cyantraniliprole.

According to an embodiment of the present disclosure, the stable agrochemical composition comprises from about 0.1% w/w to about 50% w/w of the diamide insecticide, based on the total weight of stable agrochemical composition.

According to an embodiment of the present disclosure, the stable agrochemical composition comprises from about 0.1% w/w to about 40% w/w of the diamide insecticide, based on the total weight of stable agrochemical composition.

According to an embodiment of the present disclosure, the stable agrochemical composition comprises from about 0.1% w/w to about 30% w/w of the diamide insecticide, based on the total weight of stable agrochemical composition.

According to an embodiment of the present disclosure, the stable agrochemical composition comprises an integrity retaining system comprising disintegrant and at least two anionic surfactants.

According to an embodiment of the present disclosure, the stable agrochemical composition comprises from about 1% w/w to about 90% w/w of the integrity retaining system, based on the total weight of stable agrochemical composition.

According to an embodiment of the present disclosure, the stable agrochemical composition comprises from about 5% w/w to about 90% w/w of the integrity retaining system, based on the total weight of stable agrochemical composition.

According to an embodiment of the present disclosure, the stable agrochemical composition comprises from about 10% w/w to about 80% w/w of the integrity retaining system, based on the total weight of stable agrochemical composition.

According to an embodiment of the present disclosure, the disintegrant of the integrity retaining system comprises an organic salt, an inorganic salt, a natural polymer based on sugar and starch, a mineral clay, or a combination thereof.

According to an embodiment of the present disclosure, the organic salts comprise a salts or derivatives of a lactate, an oxalate, an acetate, a sorbate, pyrrolidone, or a combination thereof. In an aspect, the disintegrant comprises or consists of sodium acetate, sodium citrate, or a combination thereof.

According to an embodiment of the present disclosure, the inorganic salts comprise ammonium sulfate, sodium sulfate, ammonium phosphate, sodium phosphate, sodium dihydrogen phosphate, copper sulfate, ferric sulfate, ferric chloride, magnesium oxide, sodium silicate, or a combination thereof.

According to an embodiment of the present disclosure, the natural polymers based on sugar and starch comprise lactose, maltose, dextrose, mannose, or a combination thereof.

According to an embodiment of the present disclosure, the mineral clays comprise kaolin, bentonite, zeolite, gypsum, or a combination thereof.

According to an embodiment of the present disclosure, the disintegrant of the integrity retaining system comprises ammonium sulfate, lactose, maltose, sodium sulfate, ammonium bicarbonate, ammonium phosphate, sodium bicarbonate, magnesium sulfate, hydrogen carbonate, sodium chloride, sodium citrate, kaolin, gypsum, calcium carbonate, sodium dihydrogen carbonate, sodium dihydrogen phosphate, ammonium citrate, sodium acetate bentonite, aluminium chloride, citric acid, succinic acid, or a combination thereof.

According to an embodiment of the present disclosure, the stable agrochemical composition comprises from about 1% w/w to about 90% w/w of disintegrant based on the total weight of stable agrochemical composition.

According to an embodiment of the present disclosure, the stable agrochemical composition comprises from about 5% w/w to about 80% w/w of disintegrant based on the total weight of stable agrochemical composition.

According to an embodiment of the present disclosure, the stable agrochemical composition comprises from about 10% w/w to about 70% of disintegrant based on the total weight of stable agrochemical composition.

According to an embodiment of the present disclosure, the integrity retaining system comprises at least two anionic surfactants.

According to an embodiment of the present disclosure, the at least two anionic surfactants of the integrity retaining system comprise at least two of a substituted, polymeric alkyl or aryl sulfonate such as a sodium alkylnaphthalene sulfonate, sodium naphthalene sulfonate, a sodium alkylnaphthalene sulfonate formaldehyde condensate, calcium lignosulfonate, sodium lignosulfonate, ammonium lignosulfonate, sodium diisopropylnaphthalene sulfonate, sodium salt of an arylsulphonic acid methylene linked condensate, a sodium alkyl naphthalene sulfonate-formaldehyde condensate, or a combination thereof.

According to an embodiment of the present disclosure, the integrity retaining system comprises two anionic surfactants.

According to an embodiment of the present disclosure, the at least two anionic surfactants comprise, consist essentially of, or consist of sodium lignosulfonate and alkyl naphthalene sulfonate.

According to an embodiment of the present disclosure, the at least two anionic surfactants comprise, consist essentially of, or consist of alkyl naphthalene sulfonate and sodium alkylnaphthalenesulfonate formaldehyde condensate.

According to an embodiment of the present disclosure, the at least two anionic surfactants comprise, consist essentially of, or consist of sodium lignosulfonate and sodium diisopropylnaphthalene sulfonate.

According to an embodiment of the present disclosure, the integrity retaining system comprises three anionic surfactants.

According to an embodiment of the present disclosure, the three anionic surfactants comprise, consist essentially of, or consist of sodium diisopropylnaphthalene sulfonate, a sodium alkylnaphthalenesupfonate formaldehyde condensate, and sodium lignosulphonate. According to an embodiment of the present disclosure, the three anionic surfactants comprise, consist essentially of, or consist of an alkyl naphthalene sulfonate of sodium salt, a sodium salt of arylsulphonic acid methylene linked condensate, and sodium lignosulphonate.

According to an embodiment of the present disclosure, the stable agrochemical composition comprises from about 0.1% w/w to about 50% w/w of the at least two anionic surfactants based on the total weight of the stable agrochemical composition.

According to an embodiment of the present disclosure, the stable agrochemical composition comprises from about 0.5% w/w to about 40% w/w of the at least two anionic surfactants based on the total weight of the stable agrochemical composition.

According to an embodiment of the present disclosure, the stable agrochemical composition comprises from about 1% w/w to about 30% w/w of the at least two anionic surfactants based on the total weight of the stable agrochemical composition.

According to an embodiment of the present disclosure, a stable agrochemical composition comprising:
a) at least one diamide insecticide; and
b) an integrity retaining system comprising disintegrant and at least two anionic surfactants;
wherein ratio of the disintegrant to the at least two anionic surfactants is from about 0.5:1 to about 5:1.

Unless otherwise indicated, the ratios disclosed throughout the specification are weight ratios.

According to an embodiment of the present disclosure, the ratio of disintegrant to the at least two anionic surfactants is from about 0.5 to about 1.

According to an embodiment of the present disclosure, the ratio of disintegrant to the at least two anionic surfactants is from about 1 to about 1.

According to an embodiment of the present disclosure, the ratio of disintegrant to the at least two anionic surfactants is from about 2 to about 1.

According to an embodiment of the present disclosure, the ratio of disintegrant to the at least two anionic surfactants is from about 3 to about 1.

According to an embodiment of the disclosure, the stable agrochemical composition comprises:
a) at least one diamide insecticide;
b) at least one additional insecticide; and
c) agrochemically acceptable excipients.

According to an embodiment of the disclosure, the stable agrochemical composition comprises:
a) at least one diamide insecticide;
b) at least one additional insecticide; and
c) an integrity retaining system comprising disintegrant and at least two anionic surfactants.

According to an embodiment of the present disclosure, the at least one additional insecticide comprises a benzoylphenyl urea group, a pyrethroid group, a neonicotinoid group, a phenyl a pyrazole group, a pyrrole group, a nereistoxin analogue group, a diacylhydrazine group or a combination thereof.

According to an embodiment of the present disclosure, the pyrethroid insecticide comprises bifenthrin, lambda-cyhalothrin, cyfluthrin, cypermethrin, alpha-cypermethrin, beta-cypermethrin, or a combination thereof.

According to an embodiment of the present disclosure, the benzoylphenyl urea insecticide of comprises bistrifluron, chlorbenzuron, chlorfluazuron, dichlorbenzuron, diflubenzuron, flucycloxuron, flufenoxuron, hexaflumuron, lufenuron, novaluron, noviflumuron, penfluron, teflubenzuron, triflumuron, or a combination thereof thereof.

According to an embodiment of the present disclosure, the phenyl pyrazole insecticide of comprises acetoprole, fipronil, ethiprole, vaniliprole, or a combination thereof.

According to an embodiment of the present disclosure, the nereistoxin analogue group insecticide comprises bensultap, cartap, polythialan, thiocyclam, thiosultap, or a combination thereof.

According to an embodiment of the present disclosure, the diacylhydrazine insecticide comprises chromafenozide, furan tebufenozide, halofenozide, methoxyfenozide, or a combination thereof.

According to an embodiment of the present disclosure, the neonicotinoid insecticide comprises clothianidin, dinotefuran, imidacloprid, imidaclothiz, thiamethoxam, nitenpyram, nithiazine, acetamiprid, cycloxaprid, thiacloprid, or a combination thereof. In an aspect, the neonicotinoid insecticide comprises clothianidin, imidacloprid, acetamiprid, thiamethoxam thiacloprid, or a combination thereof According to an embodiment of the present disclosure, the pyrrole insecticide comprises chlorfenapyr.

According to an embodiment of the present disclosure, the stable agrochemical composition comprises from about 0.1% w/w to about 70% w/w of the additional insecticide based on the total weight of stable agrochemical composition.

According to an embodiment of the present disclosure, the stable agrochemical composition comprises from about 0.5% w/w to about 60% w/w of the additional insecticide based on the total weight of stable agrochemical composition.

According to an embodiment of the present disclosure, the stable agrochemical composition comprises from about 1% w/w to about 50% of the additional insecticide based on the total weight of stable agrochemical composition.

According to an embodiment of the disclosure, the stable agrochemical composition comprises chlorantraniliprole, bifenthrin, and an integrity retaining system comprising disintegrant and at least two anionic surfactants, wherein ratio of the disintegrant to the at least two anionic surfactants is from about 0.5:1 to about 5:1.

According to an embodiment of the disclosure, the stable agrochemical composition comprises chlorantraniliprole, emamectin-benzoate, and an integrity retaining system comprising disintegrant and at least two anionic surfactants, wherein ratio of the disintegrant to the at least two anionic surfactants is from about 0.5:1 to about 5:1.

According to an embodiment of the disclosure, the stable agrochemical composition comprises chlorantraniliprole, fipronil, and an integrity retaining system comprising disintegrant and at least two anionic surfactants, wherein ratio of the disintegrant to the at least two anionic surfactants is from about 0.5:1 to about 5:1.

According to an embodiment of the disclosure, the stable agrochemical composition comprises chlorantraniliprole, acetamiprid, and an integrity retaining system comprising disintegrant and at least two anionic surfactants, wherein ratio of the disintegrant to the at least two anionic surfactants is from about 0.5:1 to about 5:1.

According to an embodiment of the present disclosure, the stable agrochemical composition of the present disclosure is formulated as a solid composition. The solid composition comprises, but is not limited to, dust, powder, granules, pellets, tablets, dry flowable, wettable powder, water effervescent granules, water dispersible granules (WDG) and water emulsifiable granules.

In an embodiment, the stable agrochemical composition of the present disclosure is a Water Dispersible Granules (WDG).

In an embodiment of the present disclosure, the stable agrochemical composition further comprises at least one of non-ionic surfactants, fillers, antifoaming agents, colorants, anticaking agents, pH-regulating agents, preservatives, biocides, or other formulation aids.

Non-ionic surfactants may be selected from fatty acid glycol ester surfactants, polyalkoxylated triglyceride surfactants, alkoxylated fatty alcohol surfactants, and sorbitan fatty acid ester surfactants, polyalkoxylated alkylphenol surfactants, polyalkoxylated alkarylphenol surfactants, amine oxide surfactants, alkanolamide surfactants, glycoside surfactants, and ethylene/propylene block copolymers.

Fillers may be selected from insoluble fillers and/or soluble fillers. Non-limiting examples of the fillers include silica, amorphous silica, fumed diatomaceous earth, kaolin, clay, and bentonite.

Suitable antifoams may be selected from silicones, long-chain alcohols, and salts of fatty acids.

Suitable colorants (for example red, blue and green) include pigments, which are sparingly soluble in water, and dyes, which are water-soluble. Examples include inorganic coloring agents (for example iron oxide, titanium oxide, and iron hexacyanoferrate) and organic coloring agents (for example alizarin, azo, and/or phthalocyanine-based coloring agents).

According to an embodiment, the stable agrochemical composition comprises from about 0.1% w/w to about 50% w/w diamide insecticide and 1% w/w to about 90% w/w of the integrity retaining system, based on the total weight of the stable agrochemical composition.

According to an embodiment, the stable agrochemical composition comprises from about 0.1% w/w to about 40% w/w diamide insecticide and 5% w/w to about 90% w/w of the integrity retaining system, based on the total weight of the stable agrochemical composition.

According to an embodiment, the stable agrochemical composition comprises from about 0.1% w/w to about 30% w/w diamide insecticide and 10% w/w to about 80% w/w of the integrity retaining system, based on the total weight of the stable agrochemical composition.

According to an embodiment, the stable agrochemical composition comprises:
from about 0.1% w/w to about 50% w/w of the diamide insecticide;
from about 1% w/w to about 90% w/w of the disintegrant; and
from about 0.1% w/w to about 50% w/w of the at least two anionic surfactants, based on the total weight of the stable agrochemical composition,
wherein ratio of the disintegrant to the at least two anionic surfactants is from about 0.5:1 to about 5:1.

According to an embodiment of the present disclosure, the stable agrochemical composition comprises:
from about 0.1% w/w to about 50% w/w, or from 0.1% w/w to about 40%, or from about 0.1% w/w to about 30% of the diamide insecticide;
from about 1% w/w to about 90% w/w, or from about 5% w/w to about 80% w/w, or from about 10% w/w to about 70% w/w disintegrant; and
from about 0.1% w/w to about 50% w/w, or from about 0.5% w/w to about 40% w/w, or from about 1% w/w to about 30% w/w of the at least two anionic surfactants; and
from about 0.1% w/w to about 70% w/w, or from about 0.5% w/w to about 60% w/w, or from about 1% w/w to about 50% w/w of another insecticide based on the total weight of the stable agrochemical composition.

In another embodiment, the stable agrochemical composition comprises the diamide insecticide from about 0.1% w/w to about 40% w/w based on the total weight of the stable agrochemical composition.

In another embodiment, the stable agrochemical composition comprises the diamide insecticide from about 0.1% w/w to about 30% w/w based on the total weight of the stable agrochemical composition.

In another embodiment, the stable agrochemical composition comprises the disintegrant from about 1% w/w to about 90% w/w based on the total weight of the stable agrochemical composition.

In another embodiment, the stable agrochemical composition comprises the disintegrant from about 1% w/w to about 90% w/w based on the total weight of the stable agrochemical composition.

In another embodiment, the stable agrochemical composition comprises the disintegrant from about 5% w/w to about 80% w/w based on the total weight of the stable agrochemical composition.

In another embodiment, the stable agrochemical composition comprises the disintegrant from about 10% w/w to about 70% w/w based on the total weight of the stable agrochemical composition.

In another embodiment, the stable agrochemical composition comprises the at least two surfactants from about 0.1% w/w to about 50% w/w based on the total weight of the stable agrochemical composition.

In another embodiment, the stable agrochemical composition comprises the at least two surfactants from about 0.5% w/w to about 40% w/w based on the total weight of the stable agrochemical composition.

In another embodiment, the stable agrochemical composition comprises the at least two surfactants from about 1% w/w to about 30% w/w based on the total weight of the stable agrochemical composition.

In another embodiment, the stable agrochemical composition comprises the another insecticide from about 0.1% w/w to about 70% w/w based on the total weight of the stable agrochemical composition.

In another embodiment, the stable agrochemical composition comprises the another insecticide from about 0.5% w/w to about 60% w/w based on the total weight of the stable agrochemical composition.

In another embodiment, the stable agrochemical composition comprises the another insecticide from about 1% w/w to about 50% w/w based on the total weight of the stable agrochemical composition.

According to an embodiment of the present disclosure, the stable agrochemical composition comprises:
from about 0.1% w/w to about 50% w/w chlorantraniliprole,
from about 10% w/w to about 80% w/w ammonium sulfate,
from about 0.1% w/w to about 20% w/w sodium lignosulphonate; and
from about 0.1% to about 10% sodium diisopropylnaphthalene sulfonate,
wherein the ratio of ammonium sulfate to the total amount of sodium lignosulphonate and sodium diisopropylnaphthalene sulfonate is from about 0.5:1 to about 5:1.

According to an embodiment of the present disclosure, the stable agrochemical composition comprises:
from about 0.1% w/w to about 50% w/w chlorantraniliprole,
from about 10% w/w to about 80% w/w ammonium sulfate,
from about 0.1% w/w to about 20% w/w sodium lignosulphonate,
from about 0.1% to about 10% sodium diisopropylnaphthalene sulfonate, and
from about 0.1% w/w to about 10% w/w sodium alkyl naphthalene sulfonate-formaldehyde condensate,
wherein the ratio of ammonium sulfate to the total amount of sodium lignosulphonate, diisopropylnaphthalene sulfonate, and sodium alkyl naphthalene sulfonate-formaldehyde condensate is from about 0.5:1 to about 5:1.

In an embodiment, the ratio of ammonium sulfate to the total amount of sodium lignosulphonate, diisopropylnaphthalene sulfonate, and sodium alkyl naphthalene sulfonate-formaldehyde condensate is 1:4.42.

According to an embodiment of the present disclosure, the stable agrochemical composition comprises:
from about 0.1% w/w to about 80% w/w chlorantraniliprole,
from about 10% w/w to about 80% w/w ammonium sulfate,
from about 0.1% w/w to about 20% w/w sodium lignosulphonate,
from about 0.1% to about 10% sodium salt of arylsulphonic acid methylene linked condensate; and
from about 0.1% w/w to about 10% w/w sodium alkyl naphthalene sulfonate,
wherein the ratio of ammonium sulfate to the total amount of sodium lignosulphonate, sodium salt of arylsulphonic acid methylene linked condensate, sodium salt of arylsulphonic acid methylene linked condensate, and sodium alkyl naphthalene sulfonate is from about 0.5:1 to about 5:1.

In an embodiment, the ratio of ammonium sulfate to the total amount of sodium lignosulphonate, sodium salt of arylsulphonic acid methylene linked condensate, sodium salt of arylsulphonic acid methylene linked condensate, and sodium alkyl naphthalene sulfonate is 1:1.5.

According to an embodiment of the present disclosure, the stable agrochemical composition comprises:
from about 1% w/w to about 30% w/w chlorantraniliprole,
from about 10% w/w to about 80% w/w ammonium sulfate,
from about 1% w/w to about 40% w/w bifenthrin,
from about 0.1% w/w to about 15% w/w sodium lignosulphonate,
from about 0.1% to about 10% sodium salt of arylsulphonic acid methylene linked condensate, and
from about 0.1% w/w to about 10% w/w sodium alkyl naphthalene sulfonate,
wherein the ratio of ammonium sulfate to the total amount of sodium lignosulphonate, sodium salt of arylsulphonic acid methylene linked condensate, and sodium alkyl naphthalene sulfonate is from about 0.5:1 to about 5:1.

In an embodiment, the ratio of ammonium sulfate to the total amount of sodium lignosulphonate, sodium salt of arylsulphonic acid methylene linked condensate, and sodium alkyl naphthalene sulfonate is 1:1.1.

According to an embodiment of the present disclosure, the stable agrochemical composition comprises:
from about 1% w/w to about 30% w/w chlorantraniliprole,
from about 1% w/w to about 30% w/w emamectin-benzoate,
from about 10% w/w to about 80% w/w ammonium sulfate,
from about 0.1% w/w to about 15% w/w sodium lignosulphonate,
from about 0.1% to about 20% sodium salt of arylsulphonic acid methylene linked condensate, and
from about 0.1% w/w to about 10% w/w sodium alkyl naphthalene sulfonate,
wherein the ratio of ammonium sulfate to the total amount of sodium lignosulphonate, sodium salt of arylsulphonic acid methylene linked condensate, and sodium alkyl naphthalene sulfonate is from about 0.5:1 to about 5:1.

In an embodiment, the ratio of ammonium sulfate to the total amount of sodium lignosulphonate, sodium salt of arylsulphonic acid methylene linked condensate, and sodium alkyl naphthalene sulfonate is 1:0.96.

According to an embodiment of the present disclosure, the stable agrochemical composition comprises:
from about 1% w/w to about 30% w/w chlorantraniliprole,
from about 1% w/w to about 30% w/w acetamiprid,
from about 10% w/w to about 80% w/w ammonium sulfate,
from about 0.1% w/w to about 15% w/w sodium lignosulphonate, and
from about 0.1% to about 20% alkyl naphthalene sulfonate,
wherein the ratio of ammonium sulfate to the total amount of sodium lignosulphonate and alkyl naphthalene sulfonate is from about 0.5:1 to about 5:1.

In an embodiment, the ratio of ammonium sulfate to the total amount of sodium lignosulphonate and alkyl naphthalene sulfonate is 1:1.25.

According to an embodiment of the present disclosure, the stable agrochemical composition comprises:
from about 0.1% w/w to about 30% w/w chlorantraniliprole,
0.1% w/w to about 50% w/w fipronil,
from about 10% w/w to about 80% w/w ammonium sulfate,
from about 0.1% w/w to about 20% w/w sodium lignosulphonate,
from about 0.1% to about 10% sodium diisopropylnaphthalene sulfonate, and
from about 0.1% to about 10% sodium alkyl naphthalene sulfonate-formaldehyde condensate,
wherein the ratio of ammonium sulfate to the total amount of sodium lignosulphonate and sodium alkyl naphthalene sulfonate-formaldehyde condensate is from about 0.5:1 to about 5:1.

According to an embodiment of the present disclosure, the stable agrochemical composition comprises:
from about 1% w/w to about 30% w/w chlorantraniliprole,
10% w/w to about 50% w/w fipronil,
from about 10% w/w to about 80% w/w kaolin,
from about 0.1% w/w to about 20% w/w sodium lignosulphonate,
from about 0.1% to about 10% sodium diisopropylnaphthalene sulfonate, and
from about 0.1% to about 10% sodium alkyl naphthalene sulfonate-formaldehyde condensate,
wherein the ratio of kaolin to the total total amount of sodium lignosulphonate, sodium diisopropylnaphthalene sulfonate, and odium alkyl naphthalene sulfonate-formaldehyde condensate is 1.1.9.

According to an embodiment of the present disclosure, a process of preparing a stable agrochemical composition comprises:
i. combining least one diamide insecticide, a disintegrant, at least two anionic surfactants, and optionally an auxiliary ingredient to obtain a blend;
ii. mixing and homogenizing the blend;
iii. preparing the granules from the blend to obtain the stable agrochemical composition comprising the at least one diamide insecticide and an integrity retaining system comprising the disintegrant and the at least two anionic surfactants.

According to an embodiment, the ratio of disintegrant to the at least two anionic surfactants is from about 0.5:1 to about 5:1.

According to an embodiment of the present disclosure, a process of preparing a stable agrochemical composition comprises:
i. combining at least one diamide insecticide, an additional insecticide, at least two anionic surfactants, a disintegrant, and optionally an auxiliary ingredient to obtain a blend;
ii. mixing and homogenizing the blend; and
iii. preparing granules from the blend to obtain the stable agrochemical composition comprising the at least one diamide insecticide, the additional insecticide, and the integrity retaining system comprising the disintegrant and the at least two anionic surfactants. According to an embodiment, the ratio of disintegrant to the at least two anionic surfactants is from about 0.5:1 to about 5:1.

According to an embodiment of the present disclosure, the preparing of the granules from the blend comprises granulating the blend.

According to an embodiment of the present disclosure, a process of preparing a stable agrochemical composition comprises:
i. combining at least one diamide insecticide, a disintegrant, at least two anionic surfactants, and optionally an auxiliary ingredient to obtain a blend;
ii. grinding the blend to obtain a ground mixture having a predetermined particle size;
iii. blending the ground mixture to obtain a homogeneous mixture;
iv. preparing dough from the homogeneous mixture and preparing granules from the dough; and
v. drying the granules to obtain the agrochemical composition comprising: (a) the at least one diamide insecticide; and (b) an integrity retaining system comprising the disintegrant and the at least two anionic surfactants. In an embodiment, the ratio of the disintegrant to the at least two anionic surfactants is from about 0.5:1 to about 5:1.

According to an embodiment of the present disclosure, the process comprises:
i. combining chlorantraniliprole, sodium diisopropylnaphthalene sulfonate, sodium alkyl naphthalene sulfonate-formaldehyde condensate, sodium lignosulphonate, ammonium sulfate and optionally an auxiliary ingredient to obtain a blend;
ii. grinding the blend to obtain a ground mixture having a predetermined particle size;
iii. blending the ground mixture to obtain a homogeneous mixture;
iv. preparing a dough from the homogeneous mixture and preparing the granules from the dough; and
v. drying the granules to obtain the stable agrochemical composition comprising: (a) chlorantraniliprole; and (b) an integrity retaining system comprising ammonium sulfate, sodium diisopropylnaphthalene sulfonate, sodium alkyl naphthalene sulfonate-formaldehyde condensate, sodium lignosulphonate, ammonium sulfate, and optionally the auxiliary ingredient. In an embodiment, the ratio of ammonium sulfate to the total amount of sodium diisopropylnaphthalene sulfonate, sodium alkyl naphthalene sulfonate-formaldehyde condensate, and sodium lignosulphonate, is from about 0.5:1 to about 5:1.

According to an embodiment of the present disclosure, the combining of the above ingredients to obtain a blend is performed using a suitable blender such as ribbon blender, V-blender, and high intensity plough shear mixer.

According to an embodiment of the present disclosure, the grinding of the blend may be performed in any suitable device such as air jet mill, air classifier mill, hammer mill, and/or pin disc mill. Jet mills are shear or pulverizing machines in which the particles to be milled are accelerated by gas flows and pulverized by collision. There are a number of different types of jet mill designs, such as double counterflow (opposing jet) and spiral (pancake) fluid energy mills.

According to an embodiment of the present disclosure, the formation of water dispersible granules is performed by a process including, for example, extrusion, pan granulation, fluidised bed spray granulation, spray drying, or a combination thereof.

According to an embodiment of the present disclosure, the drying of the granules may be performed in any suitable drying equipment such as a fluidised bed drier, a tray drier, and/or a Rotocone vacuum drier.

According to an embodiment, the temperature at which the granules are dried is not necessarily limited as long as the temperature is not greater than 90° C.-100° C.

According to an embodiment, the drying of the granules is performed at a temperature in the range of about 50° C. to about 70° C.

The drying process preferably removes as much water as possible from the granules in order to reduce weight and to provide good stability to the granules while still in a dry flowable state. Preferably the amount of water retained in the granules is less than 2% following complete drying.

The drying process preferably removes as much water as possible from the granules in order to reduce weight and to provide good stability to the granules while still in a dry flowable state. Preferably the amount of water retained in the granules is less than 2% following complete drying. More preferably the amount of water retained in the granules is less than 0.5% following complete drying.

According to an embodiment of the present disclosure, dried granules are subjected to sieving to remove undersized and oversized granules.

According to an embodiment of the present disclosure, processing time of granules is from about 30 min to 1 hour.

According to an embodiment of the present disclosure, the suspensibility of the granules is at least 80% w/w.

According to an embodiment of the present disclosure, the suspensibility of the granules is at least 85% w/w.

According to an embodiment of the present disclosure, the suspensibility of the granules is at least 90% w/w.

According to an embodiment of the present disclosure, dispersibility of the granules is at least 80% w/w.

According to an embodiment of the present disclosure, dispersibility of the granules is at least 85 w/w.

According to an embodiment of the present disclosure, dispersibility of the granules is at least 90% w/w.

According to an embodiment of the present disclosure, attrition resistance of the granules is at least 98% w/w.

According to an embodiment of the present disclosure, attrition resistance of the granules is at least 99% w/w.

According to an embodiment of the present disclosure, attrition resistance of the granules is at least 99.5% w/w.

According to an embodiment of the present disclosure, the moisture content of the granules is less than or equal to 2%.

According to an embodiment of the present disclosure, the moisture content of the granules is less than or equal to 1%.

According to an embodiment of the present disclosure, the moisture content of the granules is less than or equal to 0.5%.

According to an embodiment of the present disclosure, the wettability of the granules preferably is less than or equal to about 60 seconds.

According to an embodiment of the present disclosure, the wettability of the granules preferably is less than or equal to about 50 seconds.

According to an embodiment of the present disclosure, the wettability of the granules preferably is less than or equal to about 40 seconds.

According to an embodiment of the present disclosure, wet sieve retention on a 200 BSS sieve of the granules is less than or equal to about 1 w/w.

According to an embodiment of the present disclosure, wet sieve retention on a 200 BSS sieve of the granules is less than or equal to about 0.75 w/w.

According to an embodiment of the present disclosure, wet sieve retention on a 200 BSS sieve of the granules is less than or equal to about 0.5 w/w.

Below table provides details of methods followed while checking various stability aspects of compositions prepared according to present disclosure.

TABLE 1

| Parameter | CIPAC/Internal method |
|---|---|
| Active Content (% w/w) | HPLC |
| Suspensibility (% w/w) | MT 184 |
| Moisture Content (% w/w) | LOD method: LOD at 105 degree |
| | for 15 minutes |
| Wettability (in Sec) | MT 53.3 |
| Wet Sieve Retention on | MT 185 |
| 200 BSS Sieve (% w/w) | |
| Foam Test after 1 ml | MT 47.2 |
| (foam in ml) | |
| Degree of Dispersion (% w/w) | MT 174 |
| Attrition Resistance (% w/w) | MT 178 |
| Number of Inversion | Take 2 g sample in 250 ml water in a |
| | suspensibility cylinder. Invert the |
| | cylinder at 180° and bringing back |
| | to normal (called stoke). Record the |
| | stokes required for complete |
| | dispersion of sample. |

According to an embodiment of the present disclosure, the materials disclosed herein may be in a finely divided form, preferably in an air-milled form, which is generally the form of technical grade chemicals supplied by manufacturers.

After thorough mixing, or after putting the mix into a form suitable for extrusion, extrusion takes place through suitable orifice. The size of the granules will depend upon the size of the orifice and the extruder may thus be fitted with a mesh or die selected to provide a desired granule size. Preferably extrusion orifices will be chosen to provide extrusions having a diameter between 300 μm and 3000 μm. The extrusions can vary considerably in length, e.g. up to 0.5 cm or greater.

In an embodiment of the present disclosure, the pH of the stable solid agrochemical composition is adjusted as needed to a pH of 5 to 8.

The process of the disclosure considerably reduces the amount of oversized and undersized material which must be recycled. Consequently, the granule composition is essentially dust free.

According to an embodiment of the present disclosure, a method of controlling plant pests comprises applying to the plant or a locus thereof an agrochemical composition comprising:
a) at least one diamide insecticide; and
b) an integrity retaining system comprising a disintegrant and at least two anionic surfactants to plants or to their locus.

According to an embodiment of the present disclosure, the ratio of the disintegrant to the at least two anionic surfactants is from about 0.5:1 to about 5:1.

In an embodiment, there is provided use of an agrochemical composition comprising at least one diamide insecticide; and an integrity retaining system comprising a disintegrant and at least two anionic surfactants for controlling plant pests.

In an embodiment, there is provided use of an agrochemical composition comprising at least one diamide insecticide; and an integrity retaining system comprising a disintegrant and at least two anionic surfactants for controlling plant pests by applying to the plant or a locus thereof an effective amount of an agrochemical composition.

According to an embodiment of the present disclosure, a method of controlling plant pests comprises applying to the plant or a locus thereof an effective amount of an agrochemical composition comprising:
a) at least one diamide insecticide;
b) an additional insecticide; and
c) an integrity retaining system comprising a disintegrant and at least two anionic surfactants to plants or to their locus.

According to an embodiment the ratio of the disintegrant to the at least two anionic surfactant is from about 0.5:1 to about 5:1.

According to an embodiment of the present disclosure, the diamine insecticide comprises or consists of chlorantraniliprole; and the additional insecticide comprises or consists of bifenthrin, lambda-cyhalothrin, acetamiprid, imidacloprid, fipronil, flonicamid, cartap-hydrochloride, emamectin-benzoate, novaluron, or a combination thereof.

The ingredients of the present disclosure may be sold as a pre-mixed composition. Alternatively, they may be provided individually as separate parts of a kit and may be mixed together before spraying. In a separate embodiment, at least one adjuvant may also be included with the kit and mixed together with the diamide insecticides.

The composition of the present disclosure maybe applied simultaneously as a tank mix or formulation or the diamide insecticides and additional insecticides may be applied sequentially. Alternatively, the application may be a post-emergent application. The application may be made to the soil before emergence of the plants, either pre-planting or post-planting. The application may be made as a foliar spray at different timings during crop development, with either one or two applications early or late post-emergence.

The compositions according to this disclosure can be applied before or after infection of the plants or the propagation material thereof by the insects.

It will be understood that the specification and examples are illustrative but not limiting of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the disclosure.

### EXAMPLES

### Example 1: Chlorantraniliprole 35% w/w Water Dispersible Granules (Working Example)

The materials in Table 2 were used to prepare the insecticide composition of Example 1.

TABLE 2

| Active Ingredients | Quantity (% w/w) |
|---|---|
| Chlorantraniliprole | 35 |
| Sodium diisopropylnaphthalene sulfonate | 3 |
| Sodium alkyl naphthalene | 6 |
| sulfonate-formaldehyde condensate | |
| Sodium lignosulphonate | 3 |
| Ammonium sulfate | q. s |

Chlorantraniliprole, sodium diisopropyl naphthalene sulfonate, sodium alkylnaphthalene sulphonate formaldehyde condensate, sodium lignosulphonate, and ammonium sulfate were combined in the quantities shown in Table 2 and blended in a ribbon blender for 20-30 min to obtain a blend. The blend was further ground in an air jet mill to obtain a ground mixture having a particle size D₁₀₀ of less than 30 micrometers (μm). The ground mixture was further blended for 40-50 min to obtain a homogeneous mixture. A water spray was applied to the homogeneous mixture to prepare a dough. Granules were then prepared by extrusion in a granulator having sieve size of 0.8 to 1.2 mm aperture. The extruded granules were dried on fluid bed dryer at a temperature between 50° C. to 70° C. The dried granules were passed through 200 BSS sieve to obtain uniform sized granules. Undersized and oversized granules were recycled back.

### Example 2: Chlorantraniliprole 70% w/w WDG (Working Example)

The materials in Table 3 were used to prepare the insecticide composition of Example 2.

TABLE 3

| Active Ingredients | Quantity (% w/w) |
|---|---|
| Chlorantraniliprole | 70 |
| Sodium diisopropylnaphthalene sulfonate | 3 |
| Sodium alkyl naphthalene | 6 |
| sulfonate-formaldehyde condensate | |
| Sodium lignosulphonate | 3 |
| Ammonium sulfate | q. s |

Chlorantraniliprole, sodium diisopropylnaphthalene sulfonate, sodium alkyl naphthalene sulfonate-formaldehyde condensate, sodium lignosulphonate and ammonium sulfate were combined in the amounts shown in Table 3 and water dispersible granules were prepared as described in Example 1.

### Example 3: Chlorantraniliprole 12% w/w+Bifenthrin 32% w/w WDG (Working Example)

The materials in Table 4 were used to prepare the insecticide composition of Example 3.

TABLE 4

| Active Ingredients | Quantity (% w/w) |
|---|---|
| Chlorantraniliprole | 12 |
| Bifenthrin | 32 |
| Sodium alkyl naphthalene sulfonate | 4 |
| Sodium salt of arylsulphonic acid methylene | 8 |
| linked condensate | |
| Sodium lignosulfonate | 14 |
| Castor oil ethoxylate 40 mole | 1 |
| Polydimethylsiloxane emulsion | 0.5 |
| Ammonium sulfate | QS |

Chlorantraniliprole, bifenthrin, sodium alkyl naphthalene sulfonate, sodium salt of arylsulphonic acid methylene linked condensate, sodium lignosulfonate, castor oil ethoxylate 40 mole, a polydimethylsiloxane emulsion, and ammonium sulfate were combined in the amounts shown in Table 4, and water dispersible granules were prepared as described in Example 1.

### Example 4: Chlorantraniliprole 24%+Emamectin-Benzoate 8.8% WDG (Working Example)

The materials in Table 5 were used to prepare the insecticide composition of Example 4.

TABLE 5

| Active Ingredients | Quantity (% w/w) |
|---|---|
| Chlorantraniliprole | 24 |
| Emamectin benzoate | 8.8 |
| Sodium alkyl naphthalene sulfonate | 6 |
| Sodium salt of arylsulphonic acid | 16 |
| methylene linked condensate | |
| Sodium lignosulfonate | 12 |
| Polydimethylsiloxane emulsion | 0.5 |
| Ammonium sulfate | QS |

Chlorantraniliprole, emamectin-benzoate, sodium alkyl naphthalene sulfonate, sodium salt of arylsulphonic acid methylene linked condensate, sodium lignosulphonate, polydimethylsiloxane emulsion and ammonium sulfate were combined in the amounts shown in Table 5, and water dispersible granules were prepared as described in Example 1.

### Example 5: Chlorantraniliprole 20% w/w+Acetamiprid 20% w/w (Working Example)

The materials in Table 6 were used to prepare the insecticide composition of Example 5.

TABLE 6

| Active Ingredients | Quantity (% w/w) |
|---|---|
| Chlorantraniliprole | 20 |
| Acetamiprid | 20 |
| Sodium lignosulfonate | 13.5 |
| Alkyl naphthalene sulfonate | 3.5 |
| Ammonium sulfate | 21 |
| Antifoam | 0.6 |
| Kaolin | QS |

Chlorantraniliprole, acetamiprid, sodium lignosulfonate, alkyl naphthalene sulfonate, ammonium sulfate, kaolin, and antifoam were combined in the amounts shown in Table 6, and water dispersible granules were prepared as described in Example 1.

### Example 6: Chlorantraniliprole 12% w/w+Fipronil 30% w/w WDG (Working Example)

The materials in Table 7 were used to prepare the insecticide composition of Example 6.

TABLE 7

| Active Ingredients | Quantity (% w/w) |
|---|---|
| Chlorantraniliprole | 12 |
| Fipronil | 30 |
| Sodium diisopropylnaphthalene | 4 |
| sulfonate | |
| Sodium alkyl napthalene | 4 |
| sulfonate-formaldehyde condensate | |
| Sodium lignosulphonate | 12 |
| Antifoam | 0.5 |
| Ammonium sulfate | 8 |
| Kaolin | QS |

Chlorantraniliprole, fipronil, sodium diisopropylnaphthalene sulfonate, sodium alkyl naphthalene sulfonate-formaldehyde condensate, sodium lignosulphonate, antifoam, ammonium sulfate and kaolin were added in the amounts shown in Table 7 and water dispersible granules were prepared as described in Example 1.

### Example 7: Chlorantraniliprole 35% w/w WDG (Comparative Example)

The materials in Table 8 were used to prepare the insecticide composition of Example 7.

TABLE 8

| Ingredients | Quantity (% w/w) |
|---|---|
| Chlorantraniliprole | 35 |
| Sodium alkyl naphthalene | 6 |
| sulfonate-formaldehyde condensate | |
| Ammonium sulfate | qs |
| Total | 100 |

Chlorantraniliprole, sodium alkyl naphthalene sulfonate-formaldehyde condensate, and ammonium sulfate were combined in the amounts shown in Table 8 and granules were prepared as described in Example 1.

### Example 8: Chlorantraniliprole 70% w/w WDG (Comparative Example)

The materials in Table 9 were used to prepare the insecticide composition of Example 8.

TABLE 9

| Ingredients | Quantity (% w/w) |
|---|---|
| Chlorantraniliprole | 70 |
| Sodium diisopropylnaphthalene | 3 |
| sulfonate | |
| EO-PO block copolymer | 3 |
| Castor oil ethoxylate 40 mole | 3 |
| Ammonium sulfate | 21 |
| Total | 100 |

Chlorantraniliprole, sodium diisopropylnaphthalene sulfonate, ethylene oxide-propylene oxide (EO-PO) block copolymer, castor oil ethoxylate 40 mol (PEG-40 hydrogenated castor oil), and ammonium sulfate were mixed in the amounts shown in Table 9, and granules were prepared as described in Example 1.

### Example 9: Chlorantraniliprole 24% w/w and Emamectin-Benzoate 8.8% w/w WDG (Comparative Example)

The materials in Table 10 were used to prepare the insecticide composition of Example 9.

TABLE 10

| Ingredients | Quantity (% w/w) |
|---|---|
| Chlorantraniliprole | 24 |
| Emamectin Benzoate | 8.8 |
| Sodium salt of arylsulphonic acid | 10 |
| methylene linked condensate | |
| Antifoam | 0.5 |
| Ammonium sulfate | 56.7 |

Chlorantraniliprole, Emamectin benzoate, sodium salt of arylsulphonic acid methylene linked condensate, antifoam and ammonium sulfate were mixed in the amounts shown in Table 10 and granules were prepared as described in Example 1.

### Example 10: Chlorantraniliprole 12% w/w and Fipronil 30% w/w WDG (Comparative Example)

The materials in Table 11 were used to prepare the insecticide composition of Example 10.

TABLE 11

| Ingredients | Quantity (% w/w) |
|---|---|
| Chlorantraniliprole | 12 |
| Fipronil | 30 |
| Sodium diisopropylnaphthalene | 4 |
| sulfonate | |
| Ammonium sulfate | qs |

Chlorantraniliprole, fipronil, sodium diisopropylnaphthalene sulfonate and ammonium sulfate were mixed in the amounts shown in Table 11 and granules were prepared as described in Example 1.

### Stability Study

The compositions of Examples 1-6 were prepared as water dispersible granules. These compositions were then tested for stability based on various parameters in ambient conditions, i.e., just after preparation of granules in room temperature and also in accelerated heat stability (AHS) conditions, i.e., storage at 54° C. for 2 weeks. The stability results in ambient condition are presented in Table 12 and the stability results resulting from AHS conditions are presented in Table 13.

For the compositions of Examples 1, 2, 3, 4, 5 and 6, chlorantraniliprole was found to be quite stable and only a very minute amount of degradation (less than 0.5%) was observed in AHS conditions. The suspensibility of chlorantraniliprole in each of the Example 1-6 water dispersible granule compositions was greater than 85% in ambient conditions and greater than 75% in AHS conditions. Similarly, suspensibility of the additional active agent was also observed to be greater than 85% in ambient conditions and greater than 75% in AHS conditions. All the compositions exhibited satisfactory wettability in ambient conditions as well as AHS conditions that was substantially less than 60 sec. The moisture content in Examples 1-6 was less than 2%. In most of the compositions, there was no wet sieve retention and in Examples 3 and 4 it was less than 1%.

The degree of dispersion of the granules in water for each of Examples 1-6 was greater than 90% w/w in ambient conditions as well as in AHS conditions. Also, the number of inversions was found to be less than 20 in each of Examples 1-6 in ambient conditions as well as in AHS conditions. Attrition resistant was calculated for the compositions of Example 1-6 in ambient conditions and found to be greater than 99% in all of the compositions. This demonstrated the effectiveness of the integrity retaining system disclosed herein.

The compositions of Examples 1 and 2 were prepared without using an antifoaming agent, but the integrity retaining system controlled the foaming behaviour. All of the compositions of Example 1-6 offered lesser processing time in terms of handling of the active ingredients as well as the integrity retaining system in granule formation. The overall processing time for these compositions was from 30 mins to 1 hour. (Table 12 and Table 13).

TABLE 12

| | Ambient Conditions | | | | | |
|---|---|---|---|---|---|---|
| Parameters | Example 1 | Example 2 | Example 3 | Example 4 | Example 5 | Example 6 |
| Chlorantraniliprole | 35.16 | 70.5 | 12.6 | 25.08 | 20.15 | 12.75 |
| active content | | | | | | |
| (% w/w) | | | | | | |
| Chlorantraniliprole | 96.5 | 96.5 | 81.68 | 85 | 94.9 | 92.78 |
| suspensibility | | | | | | |
| (% w/w) | | | | | | |
| Bifenthrin active | X | X | 31.24 | X | X | X |
| content | | | | | | |
| (% w/w) | | | | | | |
| Bifenthrin | X | X | 82.65 | X | X | X |
| suspensibility | | | | | | |
| (% w/w) | | | | | | |
| Emamectin benzoate | X | X | X | 8.91 | X | X |
| active content | | | | | | |
| (% w/w) | | | | | | |
| Emamectin-benzoate | X | X | X | 98.2 | X | X |
| suspensibility | | | | | | |
| (% w/w) | | | | | | |
| Acetamiprid active | X | X | X | X | 20.64 | X |
| content | | | | | | |
| (% w/w) | | | | | | |
| Acetamiprid | X | X | X | X | 98.4 | X |
| suspensibility | | | | | | |
| (% w/w) | | | | | | |
| Fipronil active content | X | X | X | X | X | 30.85 |
| (% w/w) | | | | | | |
| Fipronil suspensibility | X | X | | X | X | 93.74 |
| (% w/w) | | | | | | |
| Moisture Content | 0.7 | 0.94 | 1.87 | 1.89 | 1.29 | 1.66 |
| (% w/w) | | | | | | |
| Wettability (in Sec) | 5 | 5 | 25 | 30 | 5 | 6 |
| Wet Sieve Retention | Nil | Nil | 0.213 | 0.186 | Nil | Nil |
| on 200 BSS Sieve | | | | | | |
| (% w/w) | | | | | | |
| Foam Test after 1 ml | 20 | 20 | Nil | 6 | Nil | 20 |
| (foam in ml) | | | | | | |
| Degree of Dispersion | 90.12 | 90.26 | 95 | 92 | 94.84 | 93.6 |
| (% w/w) | | | | | | |
| Attrition Resistance | 99.65 | 99.72 | 99.63 | 99.56 | 99.87 | 99.90 |
| (% w/w) | | | | | | |
| Number of Inversion | 8 | 16 | 14 | 15 | 10 | 16 |
| Time of processing | 30 min- | 30 min- | 30 min- | 30 min- | 30 min- | 30 min- |
| | 1 hour | 1 hour | 1 hour | 1 hour | 1 hour | 1 hour |

X = Not applicable to the example

TABLE 13

| | Accelerated Heat Stability (AHS) @ 54° C., 2 Weeks | | | | | |
|---|---|---|---|---|---|---|
| | Example | Example | Example | Example | Example | Example |
| | 1 | 2 | 3 | 4 | 5 | 6 |
| | Description | | | | | |
| Parameters | Complies | Complies | Complies | Complies | Complies | Complies |
| Chlorantraniliprole | 35.12 | 70.42 | 11.66 | 25.04 | 20.12 | 13.08 |
| active content | | | | | | |
| (% w/w) | | | | | | |
| Chlorantraniliprole | 95.15 | 93.53 | 75.78 | 83.7 | 92.2 | 93.68 |
| suspensibility | | | | | | |
| (% w/w) | | | | | | |
| Bifenthrin as Active | X | X | 31.32 | X | X | X |
| Content | | | | | | |
| (% w/w) | | | | | | |
| Bifenthrin | X | X | 76.34 | X | X | X |
| suspensibility | | | | | | |
| (% w/w) | | | | | | |
| Emamectin-benzoate as | X | X | X | 8.84 | X | X |
| active content (% w/w) | | | | | | |
| Emamectin-benzoate | X | X | X | 96.4 | X | X |
| suspensibility | | | | | | |
| (% w/w) | | | | | | |
| Acetamiprid active | X | X | X | X | 20.63 | X |
| content (% w/w) | | | | | | |
| Acetamiprid | X | X | X | X | 97.1 | X |
| suspensibility | | | | | | |
| (% w/w) | | | | | | |
| Fipronil active content | X | X | X | X | X | 31.15 |
| (% w/w) | | | | | | |
| Fipronil suspensibility | X | X | X | X | X | 93.67 |
| (% w/w) | | | | | | |
| Moisture Content | 0.66 | 1.37 | 1.86 | 1.94 | 1.25 | 1.68 |
| (% w/w) | | | | | | |
| Wettability (in Sec) | 5 | 5 | 30 | 32 | 5 | 8 |
| Wet Sieve Retention on | Nil | Nil | 0.389 | 0.256 | Nil | Nil |
| 200 BSS Sieve | | | | | | |
| (% w/w) | | | | | | |
| Foam Test after 1 ml | 25 | 20 | Nil | 12 | Nil | 18 |
| (foam in ml) | | | | | | |
| Degree of Dispersion | 90.1 | — | 96 | 91 | 93.11 | 92.8 |
| (% w/w) | | | | | | |
| Number of Inversion | 8 | 17 | 16 | 15 | 10 | 21 |

X = Not applicable to the example

### Integrity Retaining System Screening

While developing a stable agrochemical composition comprising a diamide insecticide in the form of water dispersible granules, several disintegrants and anionic surfactants were tested in various combinations. As shown in Table 14 below, the compositions of Examples 7-10 each failed in at least one performance related physicochemical parameter. Examples 7, 9 and 10 were made using one disintegrant and only one anionic surfactant, but resulted in poor performance. In Examples 7 and 8, although suspensibility was found to be satisfactory, a greater amount of foam production was observed. The composition of Example 8 resulted in poor suspensibility and a greater number of inversions. In the composition of Example 10, good suspensibility was observed but there was substantial foam generation as well as poor disintegration and a greater number of inversions were required to disperse the contents. In each of the compositions of Examples 7 to 10, a substantial processing time was experienced. This is due to incorporation of the surfactant portion of the integrity retaining system while preparing the granules. In particular, the compositions of Examples 7-10 each took about 2-2.5 hours of processing. Based on the failed results, the inventors arrived at the conclusion that a combination of disintegrant and at least two anionic surfactants in a particular weight ratio of disintegrant to anionic surfactants is from about 0.5:1 to about 5:1, provides the greatest stability and retention of physicochemical properties. (Table 14)

TABLE 14
Comparative Examples

| | | | Example 9 | Example 10 |
|---|---|---|---|---|
| | Example 7 | Example 8 | CTPR 24% + | CTPR 12% + |
| Parameters | CTPR 35% | CTPR 70% | Emamectin 8.8% | Fipronil 30% |
| Moisture Content (% w/w) | 0.35 | 0.81 | 1.32 | 1.10 |
| Wettability (in Sec) | 5 | 5 | 32 | 6 |
| Wet Sieve Retention on 200 | NIL | NIL | 61.397 | NIL |
| BSS Sieve (% w/w) | | | | |
| Foam Test after 1 ml (foam | 70 | 70 | 24 | 71 |
| in ml) | | | | |
| Number of Inversions | 6 | 6 | >75 | 41 |
| Gravimetric Suspensibility | 87.9 | 90 | 23.82 | 95.9 |
| (% w/w) | | | | |
| Time of Processing | 2-2.5 hours | 2-2.5 hours | 2-2.5 hours | 2-2.5 hours |
| Remarks | High foam | High foam | High number of | High number of |
| | generation. | generation. | inversions | inversions |
| | | | resulted into | resulted into |
| | | | poor | poor |
| | | | dispersion. | dispersion. |
| | | | Poor | Poor |
| | | | suspensibility. | suspensibility. |

### Efficacy Study

The granules of Example 3 and Example 4 were tested for their ability to control a pest in a chickpea crop in order to evaluate the efficacy of the compositions. Trials were planned in a way such that compositions of Example 3 and Example 4 were sprayed on different zones of the chickpea crop, in duplicate. The overall effectiveness of Examples 3 and 4 was compared with an untreated check (control). The details of the experiment are outlined below.

Trial Details:
Target pest: Pod borer
Crop: Chickpea
Application type: Foliar spray using battery operated sprayer with hollow cone type nozzle
Application rate for example 3 i.e. Chlorantraniliprole 12% w/w+Bifenthrin 32% w/w WDG was 88 g a.i./Ha and Chlorantraniliprole 24%+Emamectin-benzoate 8.8% WDG was 32.8 g a.i./Ha
Water Volume: 500 L/Ha
Observations: 3 days after treatment (DAT), 7 DAT, 10 DAT and 14 DAT (DAT: Days after treatment)

The results of the experiment are shown in Table 15. It was found that the compositions of Example 3 and Example 4 were very effective in controlling the pest population significantly within a week following application. Further, there was complete control of the pest population when observations were made on the 14^{th} day following application. Therefore, it was concluded that compositions of Example-3 and Example-4 developed according to the present disclosure are not only stable but also very effective in the field. (Table-15)

TABLE 15

| | | No. of Larvae/meter row | | | | |
|---|---|---|---|---|---|---|
| # | Treatment | Pre-count | 3 DAT | 7DAT | 10 DAT | 14DAT |
| T1 | Untreated | 1.4 | 1.5 | 1.6 | 3.1 | 2.4 |
| | check | | | | | |
| T2 | Example 3 | 0.9 | 0.5 | 0.0 | 0.1 | 0.0 |
| T3 | Example 3 | 1.1 | 0.4 | 0.0 | 0.0 | 0.0 |
| T4 | Example 4 | 1.4 | 0.3 | 0.1 | 0.0 | 0.0 |
| T5 | Example 4 | 1.4 | 0.4 | 0.3 | 0.0 | 0.0 |

The inventors of the present disclosure thus successfully prepared compositions including one or more agrochemical active ingredients using an integrity retaining system comprising a disintegrant and at least two anionic surfactants. The granular compositions of present disclosure were found to retain their desired suspensibility and dispersibility while the agrochemical active ingredients were shown to remain quite stable without any significant degradation following exposure to AHS conditions. The compositions also demonstrate reduced use rates as well as a reduction in dust hazard with greater attrition resistance.

1. An agrochemical composition comprising:
a) at least one diamide insecticide; and
b) an integrity retaining system comprising a disintegrant and at least two anionic surfactants.

2. The agrochemical composition as claimed in claim 1, wherein the diamide insecticide comprises chlorantraniliprole, cyantraniliprole, tetrachlorantraniliprole, tetraniliprole, or a combination thereof.

3. The agrochemical composition as claimed in claim 1, wherein the disintegrant comprises ammonium sulfate, lactose, sodium sulfate, ammonium phosphate, sodium bicarbonate, magnesium sulfate, sodium chloride, sodium citrate, kaolin, gypsum, calcium carbonate, sodium dihydrogen carbonate, sodium dihydrogen phosphate, ammonium citrate, sodium acetate, bentonite, aluminium chloride, citric acid, succinic acid, or a mixture thereof.

4. The agrochemical composition as claimed in claim 1, wherein the at least two anionic surfactants comprise at least two of a sodium alkylnaphthalene sulfonate, a sodium naphthalene sulfonate, a sodium alkylnaphthalene sulfonate formaldehyde condensate, calcium lignosulfonate, sodium lignosulfonate, ammonium lignosulfonate, sodium diisopropyl naphthalene sulfonate, a sodium salt of an arylsulphonic acid methylene linked condensate, or a sodium alkyl naphthalene sulfonate-formaldehyde condensate.

5. The agrochemical composition as claimed in claim 1, wherein the weight ratio of disintegrant to the at least two anionic surfactants is from about 0.5:1 to about 5:1.

6. The agrochemical composition as claimed in claim 1, wherein the composition comprises
from about 0.1% w/w to about 50% w/w of the diamide insecticide,
from about 10% w/w to about 80% w/w of the disintegrant, and
from about 0.1% w/w to about 40% w/w of the at least two anionic surfactants, based on the total weight of the stable agrochemical composition,
wherein the weight ratio of disintegrant to the at least two anionic surfactants is from about 0.5:1 to about 5:1.

7. The agrochemical composition as claimed in claim 1, wherein the composition is a solid formulation.

8. The agrochemical composition as claimed in claim 1, further comprising at least one additional insecticide.

9. The agrochemical composition as claimed in claim 8, wherein the at least one additional insecticide comprises a benzoylphenyl urea group insecticide, a pyrethroid group insecticide, a neonicotinoid group insecticide, a phenyl pyrazole group insecticide, a pyrrole group insecticide, a nereistoxin analogue group insecticide, a diacylhydrazine group insecticide, or a combination thereof.

10. The agrochemical composition as claimed in claim 8, wherein the at least one additional insecticide comprises bifenthrin, lambda-cyhalothrin, acetamiprid, imidacloprid, fipronil, flonicamid, cartap-hydrochloride, emamectin-benzoate, novaluron, or a combination thereof.

11. The agrochemical composition as claimed in claim 8,
wherein the composition comprises
from about 0.1% w/w to about 50% w/w of the diamide insecticide,
from about 0.1% w/w to about 70% w/w of the at least one additional insecticide,
from about 10% w/w to about 80% w/w of the disintegrant, and
from about 0.1% w/w to about 40% w/w of the at least two anionic surfactants, based on the total weight of the stable agrochemical composition, and
wherein the weight ratio of the disintegrant to the at least two anionic surfactants is from about 0.5:1 to about 5:1.

12. A process of preparing an agrochemical composition, comprising:
i. combining at least one diamide insecticide, a disintegrant, at least two anionic surfactants, and optionally an auxiliary ingredient to obtain a blend;
ii. mixing and homogenizing the blend; and
iii. granulating the mixed and homogenized blend to obtain the agrochemical composition comprising the at least one diamide insecticide and an integrity retaining system comprising the disintegrant and the at least two anionic surfactants.

13. The process of preparing the agrochemical composition as claimed in claim 12, wherein the weight ratio of the disintegrant to the at least two anionic surfactants is from about 0.5:1 to about 5:1.

14. A method of controlling plant pests comprising applying to the plant or a locus thereof, an effective amount of the agrochemical composition of claim 1.

15. (canceled)
